(19) United States
(12) Patent Application Publication
(10) Pub. No.: US 2005/0021948 A1
(43) Pub. Date: Jan. 27, 2005

(54) Secure single drive copy method and apparatus

(76) Inventor: Franciscus Lucas Antonius Johannes Kamperman, Eindhoven (NL)

Correspondence Address: Philips Electronics North America Corporation;Corporate Patent Counsel, PO Box 3001, Briarcliff Manor, NY, 10510, US

(21) Appl. No.: 10/492,567

(22) PCT Filed: Oct. 15, 2002
(86) PCT No.: PCT/IB02/04266

(30) Foreign Application Priority Data
Oct. 17, 2001 (EP) 01203967.3

(51) Int. Cl. H04L 9/00

(52) U.S. Cl. 713/165

(57) ABSTRACT

In CD systems utilizing digital rights management (DRM), a system and method for transferring rights data and pre-encrypted content from a source disc (200) to a destination disc (300) using one playback device (400) and while protecting the integrity of the rights data from replay attacks. The system and method are also applicable in other applications involving transfers of information using storage media and data transfer devices. A transaction identifier is assigned from a list of transaction identifiers stored in the playback device. The assigned transaction identifier and the rights data read from the destination disc are encrypted using a public/private key or a symmetrical key unique to the playback device (400). The encrypted transaction identifier is transferred along with the encrypted rights data to a intermediate secure storage area (500), which may be a hard disk drive, a separate security module, or a memory area within the playback device (400) itself. The transfer of content and rights data to the destination disc (300) is authorized only if after decryption the encrypted transaction identifier can be found in the list of transaction identifiers stored in the playback device (400). If the transfer is authorized, the rights data are transferred to the destination disc (300) in an encrypted format along with the content, and the transaction identifier is deleted from list in the playback device (400) to prevent future replay attacks.

The present invention relates to the field of electronic security, and more specifically, to secure systems and methods of transferring information from one device to another.

Digital media store data in digital form, and include all the various CD and DVD optical disc technologies. The data stored on digital media can consist of video, text, audio, computer data, or any other form of digital information. Digital media frequently store copyrighted information of which high quality copies can be illegitimately made and distributed. DRM (Digital Rights Management) systems have been implemented to protect such copyrights during distribution of digital information and facilitate accounting for royalties due and/or paid to the owners of the digital information. As an example, a DRM system provides a container (i.e., a data element that securely contains and transfers digital content), a set of usage rules that must be obeyed by software and hardware devices in order to use (e.g., play back or copy) the digital content, as well as cryptographic keys that enforce the usage rules. The usage rules and cryptographic keys are hereinafter referred to as “rights data.”

To copy content and rights data from one disc to another using a single drive system, a DRM system first retrieves the content and rights data from the source disc, stores the content and rights data on a hard disk drive (HDD), transfers the content and rights data to a destination disc (the user replaces the source disc with the destination disc), and finally deletes the rights data from the HDD. An example of a “replay attack” in this context is a method of breaching a copy protection scheme where an unauthorized user such as a hacker makes a copy of the rights stored on the HDD and then attempts to deceive the DRM system into replaying the rights to a third disc. In this manner, the hacker can obtain counterfeit copies of the original. Because digital content is encrypted, it can be copied from the source medium to the destination medium by simply using a hard disk drive as an intermediate storage. Thus to prevent replay attacks, the problem is how to securely copy the rights data (that contains the cryptographic keys with which the digital content can be decrypted and accessed) as well.

It is known to define a secure authenticated channel (SAC) to securely transfer rights data from a source device and medium to a destination device and medium. According to this approach, transferring rights and copying content requires two devices and mediums which must have real-time interaction. However, a typical consumer will only have one CD-DRM drive. Furthermore, the transfer of rights must be performed in a secure manner.

Another scheme for transferring digital content while preserving associated rights includes copying only the encrypted content from a source to a destination disc. Then rights to use the content are purchased or otherwise obtained from a website or server via a protected channel (typically, a SAC). Such an approach must rely upon the integrity of a server connection.

PCT Patent Application No. W00062290 (Attorney Docket PHA 23637), which has the same assignee as the present application, discloses a single-drive system for preventing a replay attack in which a dynamic recording indicator stored in a read-only memory element of a recording medium is used to encrypt a content encryption key. The content encryption key is further encrypted using a public key that corresponds to a private key of the intended playback device. Thus, decryption of the content encryption key requires both the value of the recording indicator and the private key of the device.

Because the recording medium generates a new and possibly random recording indicator each time data is recorded onto the recording medium, a subsequent illegitimate recording (a replay attack) will not provide the same encryption key, and the playback device will be unable to decrypt the content encryption key and thus the content itself, so the replay attack is defeated. However, this approach requires that the initial recording indicator be reliably and securely communicated from the recording medium to the playback device (possibly by using a digital signature), because it is the playback device that enforces the protection scheme. Furthermore, this approach stores the recording indicator on the memory area of a recording medium that can be susceptible to unauthorized tampering.

There is a need for an improved system and method of securely transferring digital content and rights data from medium to medium using a single playback/recording device, while preventing a replay attack on a DRM or similar limited-used scheme.

The present invention fulfills the needs described above by providing a secure method of transferring rights data and digital content from a source disc to a destination disc that uses only one CD-DRM drive and an intermediate storage medium as claimed in claim 1. An encrypted transaction identifier accompanies the rights data to the intermediate storage medium so as to ensure the security of the rights data while the rights data is stored on the intermediate storage medium.

More specifically, according to an exemplary method of the present invention at least one transaction identifier is generated and stored in a memory area of a playback device (which has recording capabilities as well). The playback device assigns one of the transaction identifiers and then reads digital content and usage rights data from a source medium, decrypts the rights data, and re-encrypts the rights data and the assigned transaction identifier together using an encryption key for example incorporating symmetric cryptography or a public key that corresponds to a private key stored in the playback device.

The encryption implemented by the playback device can also incorporate a transaction key that corresponds to the assigned transaction identifier, for example by combining the transaction key with a symmetric or public key. Furthermore, in addition to encrypting the rights data and the transaction identifier together, an integrity mechanism (such as a digital signature or a hashing scheme) can be implemented to enable the detection of tampering. The playback device transfers the digital content and the re-encrypted rights data from the source medium to the local memory of a hard disk drive together with the corresponding encrypted transaction identifier. Before transferring the transferred information to a destination medium, the playback device checks the transaction identifier and any integrity mechanism to determine whether a replay attack is underway. If an integrity mechanism is also implemented, the transferred information is checked for tampering.

The replay check continues by decrypting the rights data and the encrypted transaction identifier that were transferred to the hard disk drive and comparing the transaction identifier with the transaction identifiers in the secure local memory of the playback device. The typically re-encrypted rights data is written to the destination disc only if the transferred transaction identifier matches a transaction identifier on the playback device.

An advantage of the method of the present invention is that each unique transaction identifier is stored in its unencrypted form on the more tamper resistant playback drive but is encrypted and accompanied by an integrity mechanism when the transaction identifier resides on the intermediate medium. Therefore, the present invention obviates the need for a secure intermediate medium because the security is implemented and enforced by the playback device.

Briefly described, the present invention includes systems and methods for securely transferring data (particularly, DRM-protected usage rights) using a single playback drive. At least one transaction identifier composed of a sequence or random number, is stored in a memory area within the playback drive. In one aspect of the present invention, a transaction identifier may include a reference to a unique drive identifier. Usage rights associated with content stored on a source disc are decrypted and then re-encrypted along with an assigned transaction identifier using an encryption key that is associated with the particular playback drive and which is known only to that playback drive, thereby ensuring that the rights data can only be played back to that particular playback drive. The encryption of the usage rights and transaction identifier can include a transaction key that is based upon the transaction identifier. The playback drive includes the encrypted transaction identifier when transferring the now re-encrypted usage rights along with digital content from a source disc to the memory of an intermediate medium such as a hard disk drive (HDD). Before transferring the content (which may be encrypted) and the encrypted usage rights from the HDD to a destination medium, the playback device compares the transaction identifier stored on the HDD to the list of transaction identifiers stored in the playback device. If the transaction identifier stored on the HDD matches a transaction identifier in the list of transaction identifiers, the encryption performed by the playback device is reversed and the content and the usage rights can be written to the destination medium. Furthermore, the method of the present invention can be implemented such that the rights data can be played back only once to the playback drive, by deleting the transaction identifier from playback device memory after the information from the source medium is transferred to a destination medium one time. In other words, the rights data on an intermediate medium are accepted by the playback drive only when the sequence/random number on the intermediate medium corresponds to a transaction number stored in that playback device. After the rights data has been accepted and successfully processed, the transaction identifier in the playback device is deleted to prevent the rights data from being replayed.

The maximum quantity of transaction identifiers that can be stored in a playback device depends upon the memory resources allocated by the playback device manufacturer, which may be reconfigurable after manufacture. Transaction identifiers may be generated internally or externally to the playback device prior to being stored in a transaction memory. Each transaction identifier is a unique value consisting of for example a sequence number, a randomly generated number, or a hash code of rights data. Transaction identifiers may be replenished (by generating and storing at least one new transaction identifier) when depleted, when requested, or at regular intervals, although each transaction identifier must be unique.

Another embodiment of the present invention utilizes the playback device as the intermediate medium, for example by storing usage rights in the internal memory of playback drive. When writing to the destination medium, rights data are transferred from the playback device memory and content is transferred from the intermediate medium, and are then deleted from the drive memory. This embodiment utilizes the same transaction verification techniques as the previous embodiment. The method of the present invention may also be used with a separate storage device with limited storage as the external storage location for rights data and transaction identification.

Additional objects, advantages and novel features of the invention will be set forth in part in the description which follows, and in part will become more apparent to those skilled in the art upon examination of the following, or may be learned by practice of the invention.

The accompanying drawing, which is incorporated in and forms part of the specification, illustrate the present invention when viewed with reference to the description, wherein:

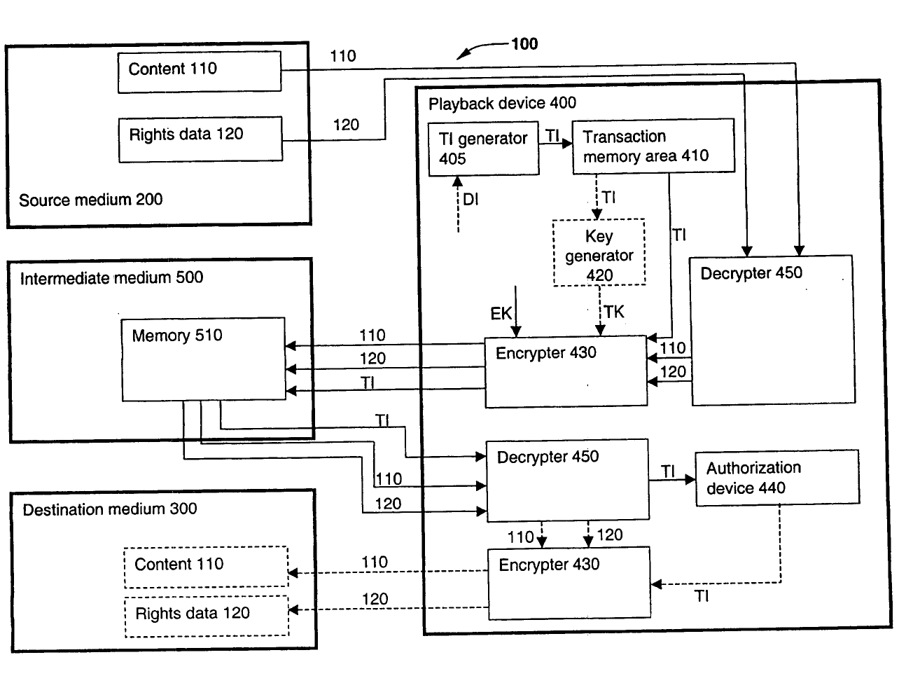

FIG. 1 is a block diagram of the functional interrelation of the elements of an exemplary embodiment of the present invention.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Referring now in detail to an exemplary embodiment of the present invention which is illustrated in the accompanying drawing in which like numerals designate like components, FIG. 1 is a block diagram of the functional elements of an exemplary embodiment of an encryption system 100 that transfers protected digital content to a destination medium 300 in such a manner as to prevent replay attacks. The encryption system 100 includes a source medium 200, a destination medium 300, and a playback device 400. The source medium 200 contains encrypted digital content 110 and associated usage rights data 120 (usage rules and cryptographic keys) that is written to the destination medium 300 for playback by the playback device 400. Any of a variety of conventional writing techniques can be employed, depending upon the form and structure of the destination medium 300. For simplicity, the components utilized to write to the destination medium 300 and read from the source medium 200 are not shown in FIG. 1.

In accordance with the present invention, the playback device 400 is identified by a unique drive identifier such as a drive number DI and includes a transaction memory area 410 that contains a list of at least one unique transaction identifier TI. The transaction memory area 410 is configured when the playback device 400 is manufactured. Transaction identifiers TI are generated by a transaction identifier generator 405 using any number of techniques and mechanisms (such as random number generation or a date/time stamp) and are stored at least once in the transaction memory area 410 after the playback device 400 is manufactured. According to an embodiment of the present invention, each transaction identifier TI is generated by the transaction identifier generator 405 as required, such as when a user desires to make a permissible copy of rights data 120. Alternatively, the transaction identifiers TI are stored in the transaction memory area 410 at the time the playback device 400 is manufactured. Each transaction identifier TI may include a reference to the drive identifier DI from which the transaction identifier originates.

The method of the exemplary embodiment of the present invention operates such that when a data transfer command has been received, a playback device 400 reads content 110 and rights data 120 from the source medium 200, either or both of which are typically pre-encrypted. A decrypter 450 decrypts the rights data 120 and alternatively also the content 1110. A transaction indicator TI issues from the list of transaction indicators stored in the transaction memory area 410. The transaction identifier TI may include a reference to a unique device identifier DI that is stored on the playback device 400 at manufacture. An encrypter 430 then encrypts the rights data 120 and the transaction identifier TI together by applying an encryption key EK that is unique to the playback device, for example a symmetrical key or a public/private key pair that was stored in the playback device at the time of manufacture.

Alternatively, the encryption of the rights data 120 and the transaction identifier TI provided by the encrypter 430 further includes transaction key TK which is generated by a key generator 420 and derived from the transaction indicator TI. The non-rights related content 110 may also be similarly encrypted by the encrypter 430. Alternatively, pre-encrypted non-rights related content may be directly copied without further encryption. So that the transfer of information from the source medium 200 to the destination medium 300 can be accomplished using only one playback device 400, the encrypted content 110 and rights data 120 are then transferred to the local memory 510 of an intermediate medium 500, along with the encrypted transaction indicator TI. The intermediate medium 500 is a storage device such as a hard disk drive (HDD) peripheral to a personal computer, an external and/or dedicated storage module, or a memory area on the playback device itself. Because the typical playback device 400 lacks sufficient memory to “cache” the entire contents of the source medium 200, the role of the intermediate medium 500 is to provide at least temporary storage of the information that is to be transferred. According to an exemplary embodiment of the present invention, the information to be transferred consists of content 110, encrypted rights data 120, and the encrypted transaction identifier TI.

In an alternate embodiment, the non-rights content 110 is transferred to an intermediate medium while the encrypted rights data 120 and the encrypted transaction indicator TI are transferred to a memory area of the playback device 400. The encrypted state of the rights data 120 and transaction identifier TI and the implementation of an integrity mechanism provide tamper detection and confidentiality of data while the data is stored on the intermediate medium 500.

The replay defense is implemented primarily when the source medium 200 is disengaged from the playback device 400 and is then replaced with a destination medium 300. At this stage in the process, the playback device 400 continues to process the request to transfer the content 110 and the rights data 120 to the destination medium 300 via the intermediate medium 500 to which the information was previously transferred in an encrypted state. To verify the legitimacy of the transfer request, an authorization device 440 of the playback device 400 checks the integrity mechanism to detect any tampering that occurred while the information was stored on the intermediate medium 500.

The decrypter 450 decrypts the transaction identifier TI (and rights data 120, as both are encrypted together) that was encrypted by the encrypter 430 and transferred to the intermediate medium 500. The decrypter 450 decrypts the information by reversing the encryption applied using the encryption key EK and the transaction key TK (if used). The authorization device 440 of the playback device 400 then compares the now decrypted transaction indicator TI that was read from the memory 510 of the intermediate medium 500 to the list of transaction indicators that is stored in the transaction memory area 410 of the playback device 400. If the value of the decrypted transferred transaction indicator TI is not found in the transaction memory area 410, the request is illegitimate and a replay attack is likely underway. If the value of the transferred transaction indicator TI is found in the transaction memory area 410, the transfer has been validated and a transfer from the intermediate medium 500 to the destination medium 300 will proceed.

To complete a validated request, an encrypter 430 within the playback device 400 re-encrypts the rights data 120 and the transaction identifier TI. The content 110 and re-encrypted rights data 120 are written to the destination medium 300 thus completing the information transfer. In an alternative embodiment, it is not necessary to re-encrypt the rights data 120 and the transaction identifier TI. According to an aspect of the present invention, the transaction identifier TI may be transferred to the destination medium as well, after also being re-encrypted.

Once the authorization device 440 has authorized or rejected a transfer request, the transaction identifier TI is deleted from the list of transaction indicators stored in the transaction memory 410 in order to prevent future replay attacks. Furthermore, the content 110, encrypted rights data 120, and transferred transaction identifier TI are deleted from the intermediate medium 500 when the authorization device 440 has rejected a transfer request. If the transfer request has been authorized by the authorization device 440, the content 110, rights data 120 (which may have changed if some rights were “consumed” after transfer), and transaction identifier TI remain on the intermediate medium 500 to facilitate additional authorized transfers as permitted by the usage rules.

In view of the foregoing, it will be appreciated that the present invention provides a system and a method for securely transferring digital content and associated rights data from medium to medium while using only one playback and recording device. Still, it should be understood that the foregoing relates only to the exemplary embodiments of the present invention, and that numerous changes may be made thereto without departing from the spirit and scope of the invention as defined by the following claims.

1. A method of securely transferring information to and from an intermediate medium (500), comprising
reading the information from a source medium (200), retrieving a transaction identifier from a memory area (410) of a playback device (400), securely coupling the information to the retrieved transaction identifier, and transferring the information along with said transaction identifier to the intermediate medium (500);
reading the securely coupled information and said transaction identifier from the intermediate medium (500), decoupling the information and said transaction identifier, comparing the transaction identifier to a set of transaction identifiers stored in the memory area (410); and
deleting said transaction identifier from said set of transaction identifiers stored on the playback device (400), if the value of said decrypted transaction identifier is found in said set of transaction identifiers stored on the playback device (400).

2. The method of claim 1, wherein securely coupling the information and the transaction identifier is implemented using key hashing and/or encryption.

3. The method of claim 1, further comprising;
decrypting the information read from the source medium (200);
re-encrypting the information along with said retrieved transaction identifier, after retrieving said retrieved transaction identifier; and
storing the information on a destination medium (300), if the value of said decrypted transaction identifier is found in said set of transaction identifiers stored on the playback device (400).

4. The method of claim 3, wherein storing the information on the destination medium (300) further comprises re-encrypting the information a second time.

5. The method of claim 3, wherein re-encrypting the information further comprises using an encryption key that is a public key that corresponds to a private key that is unique to the playback device (400).

6. The method of claim 3, wherein re-encrypting the information further comprises using an encryption key that is a symmetric key.

7. The method of claim 5, wherein encrypting the information further comprises using an additional encryption key based upon the value of the transaction identifier.

8. The method of claim 1, further comprising deleting said information and said transaction identifier from the intermediate medium (500), if said transferred transaction identifier is found in said set of transaction identifiers stored on the playback device (400).

9. The method of claim 3, further comprising storing the transferred transaction identifier on said destination medium (300), if said transferred transaction identifier is found in said set of transaction identifiers stored on the playback device (400).

10. The method of claim 1, wherein reading the information from the source medium (200) further comprises reading content material (110) and associated rights data (120) that limit access to the content material (110).

11. The method of claim 1, further comprising generating a unique transaction identifier and adding said generated transaction identifier to said set of transaction identifiers.

12. The method of claim 1, wherein said transaction identifier includes a reference to the playback device (400).

13. An apparatus for securely transferring information to and from an intermediate medium (500), comprising:
an intermediate medium (500) further comprising a memory area (510);
a transaction identifier generator (405), configured to generate transaction identifiers; and
a playback device (400), configured to decrypt the information, to re-encrypt the information, to transfer the re-encrypted information to the intermediate medium (500) along with an encrypted transaction indicator, to decrypt the information; and to delete said transaction indicator if the transaction is authorized, and which further comprises:
a transaction memory (410), configured to store a set of at least one transaction identifier;
an encrypter (430), configured to encrypt information prior to transferring the information to the intermediate medium (500); and
a decrypter (450), configured to decrypt said encrypted information; and
an authorization device (440), configured to authorize the transaction when a decrypted value of said transaction identifier stored on the intermediate medium (500) is found in said set of transaction identifiers stored in said transaction memory (410) and to reject said transfer of information when a decrypted value of said transaction identifier stored on the intermediate medium (500) is not found in said set of transaction identifiers stored in said transaction memory (410).

14. The apparatus of claim 13, wherein the playback device (400) is further configured to:
read information from a source medium (200); and
execute an authorized transfer of information by transferring the information to a destination medium (300).

15. The apparatus of claim 13, wherein the playback device (400) is further configured to encrypt the information a second time before executing the authorized transfer of information to the destination medium (300).
